(19) United States
(12) Patent Application Publication
(10) Pub. No.: US 2005/0224655 A1
(43) Pub. Date: Oct. 13, 2005

(54) Method for making a laminated structure and aircraft provided with such a structure

(76) Inventors: Dominique Guittard, Toulouse (FR); Jean-Pierre Cabanac, Tournefeuille (FR); Jany Roger, Vertou (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/001,682

(22) Filed: Dec. 1, 2004

(30) Foreign Application Priority Data
Dec. 4, 2003 (FR) 03 50976

(51) Int. Cl. B64C 1/00; B21K 7/00; B21D 53/92; B21D 47/00; B32B 7/08

(52) U.S. Cl. 244/133; 29/897.2; 29/897.32; 29/525; 29/525.01; 428/119

(57) ABSTRACT

To make a laminated structure comprising a panel made of composite materials and placed flat against at least one metal plate, the panel and the plate are presented in a stack, this stack is drilled to form a fastening borehole, a fastening rod is introduced into the bore and the fastener is fixed. In the invention, during the drilling, a negative clearance is made between a diameter of the bore and a diameter of the fastener, and when the fastener is being introduced, it is introduced from the metal plate. This mode of action prompts a positive interference that promotes the lasting nature of the fastener.

### RELATED APPLICATION

The present application claims priority to French Application No. 03 50976 filed Dec. 4, 2003.

### BACKGROUND OF THE INVENTION

1. Field of the Invention

An object of the present invention is a method for making a laminated structure and an aircraft provided with such a structure. More particularly, its field is that of aircraft construction. However, the invention can be applied in other fields. The aim of the invention is to contribute to the making of a more robust laminated structure.

2. Description of the Prior Art

Aircraft structures, typically wing units or fuselages, are built out of panels made of composite materials. For example, these panels are carbon fiber panels. These panels have the advantage of being light and particularly resistant. There are known ways of assembling such panels together to achieve substantial thickness values in the range of 110 mm to 200 mm. There also exist known ways of butt-jointing such panels one after the other one another by means of metal fishplates, which are generally metal plates. The assemblies are fixedly joined together by drilling the stack thus formed and by positioning a fastener, for example a bolt, terminated by a thread, a nut or a rivet being screwed on to this bolt.

They are known ways, in the field of metal structures, of creating positive interference values at the position of the fastener when positioning this fastener. These positive interference values are obtained by making boreholes in the stack. The diameters of these boreholes are smaller than the diameters of the fasteners to be engaged therein. These fasteners are then force-fitted into these boreholes during the fastening stage. This force-fitting leads to a plastic deformation of the metal plates in the vicinity of these bore-holes. This deformation gives the metal plates greater strength in the vicinity of the bore-holes. In practice, a negative clearance between the bore-holes and the fastener is in the range of 1% or more of the diameter of the bore-holes. In fact, the greater the interference, the greater the lifetime of the fastener.

However, for panels made of composite materials, a positive interference of this kind is prohibited, especially in aircraft. Indeed, it has been observed that it leads to cases of delamination of the panel at the position of the bore-hole. In practice, at this place, the panel becomes weaker at the bore-hole owing to this interference. This is the contrary of the goal sought. That is why, in the field of aircraft, the mounting clearance for the fasteners in the bore-hole is positive. Consequently, the loss of resistance related to the abandoning of the fastener with positive interference leads to the oversizing therein of the sizes, especially the thickness values, of the fishplates. As a result, all the fasteners give rise to additional weight, which is detrimental in aircraft.

In the invention, it was realized however that, contrary to customary practice, it is possible to make positive interference assemblies for laminated structures with composite panels, provided however that the positive interference has a value very appreciably below known values, while keeping a value in which its resistance-heightening effect is still significant. It was then realized that such a threshold existed in two conditions. In a first condition, the interference should not exceed 0.6% of the value of the bore-hole. The second condition is that, during the introduction of the fastener, the laminated structure must be held, on the side by which the fastener emerges, by a metal plate (which does not get delaminated) or by the reaction of a pulling block that prevents delamination. Typically, the pulling block has a pulling or drawing hole which is just thin enough to let through the tip of the fastener when the pulling is done and exert a reaction on the edge of the bore-hole in preventing the delamination of the other side. If the laminated structure has two metal plates that sandwich the composite panel, or at least one metal plate between the panel and the pulling block, then the stresses on the block disappear.

The idea of the invention is that it is indispensable to hold a carbon fiber panel on the side of this panel by which the fastener emerges in order to prevent delamination. For this purpose, it is possible to have a metal plate at least on the side by which the fastener emerges when it is introduced into the bore-hole. In certain cases indeed, the carbon fiber panel is even sandwiched between two metal plates. However, should there be no metal plate on the side on which the fastener emerges, it is planned to prevent the delamination by a pulling block.

### SUMMARY OF THE INVENTION

An object of the invention therefore is a method for making a laminated structure, this structure comprising, in a stack, a panel made of composite material wherein:
the panel is presented as a stack,
the stack is drilled to form a fastening bore-hole,
a round fastener rod is inserted into the bore, and
the fastener is fastened,
wherein
during the drilling, a negative clearance is made between a diameter of the bore-hole and a diameter of the fastener, and
when the fastener is being introduced, it is introduced from the panel and pulled towards a reaction plate.

An object of the invention is also an aircraft provided with a structure made according to this method.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 represents a structure mounted according to the method of the invention;

FIG. 2 is a diagrammatic view of a mounting tool that can be used with the method of the invention.

### MORE DETAILED DESCRIPTION

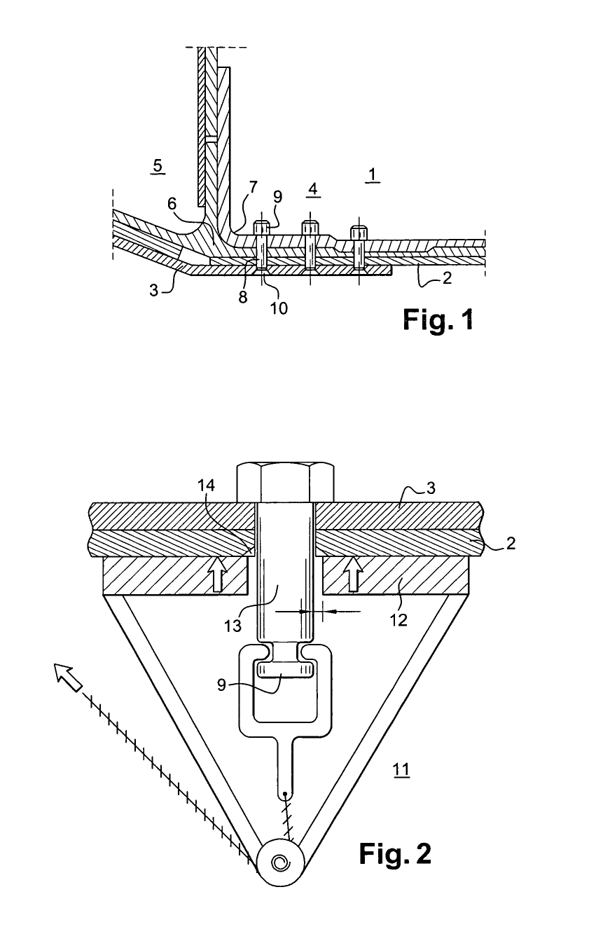

FIG. 1 shows a laminated structure 1 obtained by means of a stack containing at least one panel 2 made of a composite material and, in this case, a plate 3 made of metal, for example aluminum. The stack may comprise several composite panels placed flat against one another. In the example, the structure 1 represents a bond between a central fuselage box 4 of an aircraft and a wing unit 5. In practice here, the panel 2 is furthermore counter-secured by a triple corner-piece 6 made of aluminum. The corner-piece 6 is itself held by a single corner-piece 7. The corner-piece 6 and the plate 3 sandwich the panel 2. These different parts are joined together by fasteners such as 8. These fasteners 8 are positioned as follows. The panel 2 and the plate 3, or the panel 2, the plate 3 and the corner-pieces 6 and 7, are held together by auxiliary means. While they are held, their stack is drilled with a bore-hole through which the fastener 8 is supposed to pass. Then this fastener is introduced into the bore-hole and is fixed by being screwed in or by bolting or riveting.

In the invention, firstly the fastener is inserted from the panel 2. This means that the tip 9 of the fastener is the first to penetrate the bore through the panel 2, in this case the plate 3 before the panel 2. If need be, this tip 9 has, over a sufficient length, a diameter smaller than that of the bore-hole, enabling it to pass freely in the bore. According to another characteristic of the invention, in its useful parts, vertical to the thickness of the stack, the fastener 8 has a smooth round profile with a diameter greater than the diameter of the bore. The fastener is then drawn by its tip 9 to pass completely, so that the head 10 of the fastener comes into contact with the plate 2. Thus a positive interference is made.

In the invention, it has been discovered that if a certain limit, in practice 0.6% of the diameter, is not exceeded, a phenomenon of useful positive interference takes place. The consequence of this phenomenon is that the stem of the fastener exerts a plastic stress on the edge of the bore in the panel 2, so that the hardness of this panel is thereby strengthened at this position, leading to a better hold of the panel 2 on the plate 3, and on the corner-pieces 6 and 7 as the case may be. Naturally, the phenomenon of positive interference also occurs in the plate 3, but at this place given the metallic nature of the plate 3, and given the weakness of this interference, there is no risk of destruction to be feared. This mode of assembly can therefore be used in aircraft.

When the fastener 8 is pulled, its diameter diminishes (at least slightly). The fastener 8 then more easily penetrates the bore made in the parts to be joined. To make the fastener penetrate, a pulling tool 11, which is a hoist device 11 in one example, FIG. 2, takes support on the composite panel 2, or on another metal panel that is placed flat against this panel of composite material (the corner-piece 6 or 7 or the like, when they are present). This other metal plate, preferably acting together with the plate 3 located on the other side of the panel 2, contributes to holding the grip of the panel 2 when the fastener is inserted. They prevent delamination.

When the laminated structure has only the panel 2, with or without the metal plate 3, the hoist device 11 used for the pulling has a rigid base block 12 taking support by reaction against the panel 2 at the time of the fastening. This base block 12 has a hole 13 to receive the fastener head 9. This hole 13 is very precisely calibrated. In one example, it is calibrated to 0.6% more than the diameter of the bore. Indeed, if the hole 13 is too big then, at the exit from the panel 2, on the edge 14 of the panel, a weakening may appear. This phenomenon, which does not occur when the other plates or corner-pieces are present, is thus curbed by adjusting the diameter of the hole 13 of the base block 12. If the diameter of the hole 13 of the base block 12 is too big, there is a weakening 14. If it is too small, the fastener goes into positive interference with the base block 12, and it is no longer possible to dismount this base block 12 from the hoist device 11.

Thus, in the invention it has been discovered that the panel 2 does not get delaminated and generally does not deteriorate if the positive interference (namely the negative clearance) does not exceed 0.6%. In a preferred solution, this positive interference has the greatest possible value. In one example, it is equal to 0.3%.

In practice, the value of the positive interference essentially depends on the difference in diameter between the bore-hole and the fastener. However, it also results from the manufacturing tolerances values and the effects of elongation of the fastener when it is inserted (in fact as a result of being pulled during insertion). Consequently, it has been discovered in the invention that, from 0.6% onwards, high losses can be seen in the mechanical strength of the fastener. In other words, it has been discovered that there is a limit beyond which the positive interference is not exerted (owing to the delamination in particular), but above all, it has been discovered that, below this limit, the phenomenon of positive interference could come into play, with all the expected beneficial effects (weight gain and improved resistance), and without the feared drawbacks (weakening at the position of the fasteners).

After the introduction of the rod, the fastener 8 is fastened either by the screwing in of a nut, or by being crimped in an interference ring. In one example, the head 9 of the rod 8 gets torn off away when the pull becomes too strong, prompting automatic fastening into an interference ring. As a variant, a rivet is mounted on the head 9.

It will be noted that the preferred interference values proposed by the invention, which are below 0.6%, are far different from the known interference values when the plates to be joined are metal plates. There have thus been known ways of setting up interference values in the range of 1%, or even more, given the fact that the value of the interference directly, and almost proportionally, affects the lifetime of the fastener.

In one example, the length of a fastener 8 thus mounted in positive interference was 140 mm. This substantial thickness corresponds to a stack of several panels such as 2, which may or may not be sandwiched between metal plates such as 3. Preferably however the laminated structure is formed out of several panels made of composite material and out of metal plates interposed between the panels. The percentages given here for the bore are of course the same as those given for the diameter of the rod of the fastener 8.

1. A method for making a laminated structure, this structure comprising, in a stack, a panel made of composite material wherein:
the panel is presented as a stack,
the stack is drilled to form a fastening bore-hole,
a round fastener rod is inserted into the bore, and
the fastener is fastened,
wherein
during the drilling, a negative clearance is made between a diameter of the bore-hole and a diameter of the fastener, and
when the fastener is being introduced, it is introduced from the panel and pulled towards a reaction plate.

2. A method according to claim 1, wherein
the negative clearance is less than 0.6% of the value of the diameter of the rod.

3. A method according to claim 1, wherein
the negative clearance is equal to 0.3% of the value of the diameter of the rod.

4. A method according to claim 1, wherein
the panel made of composite material is a carbon fiber panel.

5. A method according to claim 1, wherein
prior to the drilling, the panel is placed between two metal plates.

6. A method according to claim 1, wherein
the metal of a plate is aluminum.

7. A method according to claim 1, wherein
the laminated structure is formed out of several panels made of composite material, and out of metal plates interposed between the panels.

8. A method according to claim 1, wherein
to introduce the fastener, a pulling hoist device is placed on the side of the bore-hole opposite the side by which the fastener is introduced,
the hoist device is provided with a reaction base with a pulling hole,
the pulling hole has a diameter greater than or equal to the diameter of the fastener.

9. A method according to claim 1, wherein
the panel is presented as a stack placed flat against at least one metal plate.

10. An aircraft comprising a laminated structure made according to the method that is the object of claim 1.
